(19) United States
(12) Patent Application Publication
(10) Pub. No.: US 2013/0132994 A1
(43) Pub. Date: May 23, 2013

(54) MEDIA CONTENT AGGREGATOR AND CONTENT RATING SYSTEM

(71) Applicants: Daniel Patrick Murphy, Coronado, CA (US); Rodney E. Underhill, Julian, CA (US)

(72) Inventors: Daniel Patrick Murphy, Coronado, CA (US); Rodney E. Underhill, Julian, CA (US)

(73) Assignee: EarDish Corporation

(21) Appl. No.: 13/301,426

(22) Filed: Nov. 21, 2011

(51) Int. Cl. H04N 21/63; H04N 21/43; H04N 21/83; H04N 21/23

(52) U.S. Cl. 725/23; 725/109; 725/59; 725/30

(57) ABSTRACT

Methods and systems include providing a plurality of rebroadcasting devices at a plurality of different geographic locations and controlling the plurality of rebroadcasting devices to receive local television broadcasts via their respective digital television tuners and upload the received local television broadcasts to a network server. The uploaded local television broadcasts can be received at the network server from the respective rebroadcasting devices. One or more of the uploaded local television broadcasts can be delivered to one or more computer devices via the Internet.

### FIELD

This disclosure is related to methods of aggregating media content from various sources.

### BACKGROUND

In recent years, the number of available sources of media content, such as video, audio, and audio-video content, has greatly increased. However, there is still a significant amount of content that is not accessible from locations away from where the content is produced and/or distributed. Accordingly, there remains a need for providing systems and methods that are capable of capturing and/or redistributing local content to persons wishing to access the content from more remote locations. In addition, because of these recent increases in the amount of media content available, managing the sources of information has become a significant challenge. Accordingly, it is also desirable to develop and implement methods and systems for managing media content from numerous sources.

### SUMMARY

Various systems and methods of aggregating media content for rebroadcasting are disclosed herein. In one embodiment, the method includes providing a plurality of rebroadcasting devices at a plurality of different geographic locations and controlling the plurality of rebroadcasting devices to receive local television broadcasts via their respective digital television tuners and upload the received local television broadcasts to a network server. At least some of the plurality of rebroadcasting devices can comprise digital television tuners. The uploaded local television broadcasts can be received at the network server from the respective rebroadcasting devices. One or more of the uploaded local television broadcasts can be delivered to one or more computer devices via the Internet.

In some embodiments, the act of providing the plurality of rebroadcasting devices comprises delivering a plurality of rebroadcasting devices to a plurality of users, with the plurality of users being located in different geographic locations. The act of receiving the uploaded local television broadcasts can include receiving the uploaded local television broadcasts in a different format or the same format from which they were received by the rebroadcasting devices. In some embodiments, the act of delivering one or more of the uploaded local television broadcasts to one or more computer devices via the Internet comprises rebroadcasting local television broadcasts to a user, wherein the local television broadcast is either not available via local broadcasting airwaves or available via local broadcasting airwaves, or both. In some embodiments, the plurality of users can be provided with one or more free services in exchange for their use of the rebroadcasting devices.

In other embodiments, the method can include receiving, by the server computer, media content from the Internet, media content from cable and satellite sources. In those cases, the method can comprise receiving, from one of the computing devices, an indication of whether to deliver one or more of the uploaded local television broadcasts to the one or more computer devices, media content from the Internet, or media content from cable and satellite sources to the one or more computing device. Responsive to the indication, in some embodiments, the indicated uploaded local television broadcast, media content from the Internet, or media content from cable and satellite sources can be delivered to the one or more computing device.

In another embodiment, a system for rebroadcasting local media content is provided. The system can include a plurality of rebroadcasting devices, with each rebroadcasting device comprising a television tuner for capturing digital television content, and a network server configured to control the operation of the rebroadcasting devices. The network server can be configured to select a channel for capturing digital television content for the rebroadcasting devices. The network server can be configured to receive uploaded digital television content and rebroadcast that uploaded digital television content via the Internet.

In some embodiments, the rebroadcasting devices comprise a plurality of television tuners so that the rebroadcasting devices are capable of receiving a plurality of channels at a time. The rebroadcasting devices can include a storage device, with the storage device being configured to store files of one or more captured digital television content. The storage device can be configured to store the file in a different file format than that which the rebroadcasting device originally received. In some embodiments, the network server can be configured to analyze the quality of signals received from the rebroadcasting devices and distinguish between higher quality and lower quality signals of different rebroadcasting devices for the same captured digital television content.

In another embodiment, a graphical user interface is provided for selecting media content for viewing. The graphical user interface can include a grid of selectable media content and first, second, and third groups of selectable media content. The first group of selectable media content displayed in the grid can include local broadcast-sourced media content that has been uploaded to a network server for rebroadcasting. The second group of selectable media content displayed in the grid can include Internet-sourced media content. The third group of selectable media content displayed in the grid can include subscription-based media content.

In some embodiments, the third group of selectable media content comprises one or more of cable- or satellite-sourced media content. The first group of selectable media content can include media content that has been originally broadcast in geographically diverse locations. In some implementations, the grid of selectable media content can be selected for display via the graphical user interface, at least in part, on predetermined user demographics and preferences. A location on the interface can be provided for entry of user information relating to the subscription-based media content, with this information including, in some embodiments, one or more user names and passwords.

The foregoing and other objects, features, and advantages of the invention will become more apparent from the following detailed description, which proceeds with reference to the accompanying figures.

### BRIEF DESCRIPTION OF THE DRAWINGS

FIG. 1 illustrates an exemplary system for aggregating media content from various sources.

FIG. 2 illustrates an exemplary system for capturing and rebroadcasting “local” media content for further distribution to subscribers.

FIG. 3 illustrates a screenshot of a multi-sourced television content viewing platform and application.

FIG. 4 is a schematic block diagram of an exemplary computing system on which certain embodiments of the systems and methods disclosed herein can be implemented.

FIG. 5 is a block diagram illustrating a computer network that can be used to perform at least some of the embodiments of the systems and methods disclosed herein.

FIG. 6 is a block diagram illustrating another computer network that can be used to perform at least some of the embodiments of the systems and methods disclosed herein.

FIG. 7 is a block diagram illustrating how the computer networks of FIG. 5 or 6 can be used to perform certain aspects of the systems and methods disclosed herein.

FIG. 8 illustrates a table showing the source of content viewed by a viewer.

FIG. 9 illustrates another table showing a summary of content viewed by a viewer broken down by source.

### DETAILED DESCRIPTION

### General Considerations

For purposes of this description, certain aspects, advantages, and novel features of the embodiments of this disclosure are described herein. The disclosed methods, apparatuses, and systems should not be construed as limiting in any way. Instead, the present disclosure is directed toward all novel and nonobvious features and aspects of the various disclosed embodiments, alone and in various combinations and sub-combinations with one another. The methods, apparatus, and systems are not limited to any specific aspect or feature or combination thereof, nor do the disclosed embodiments require that any one or more specific advantages be present or problems be solved.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods. Additionally, the description sometimes uses terms like “determine” and “provide” to describe the disclosed methods. These terms are high-level abstractions of the actual operations that are performed. The actual operations that correspond to these terms may vary depending on the particular implementation and are readily discernible by one of ordinary skill in the art.

Systems and Methods of Aggregating Media Content

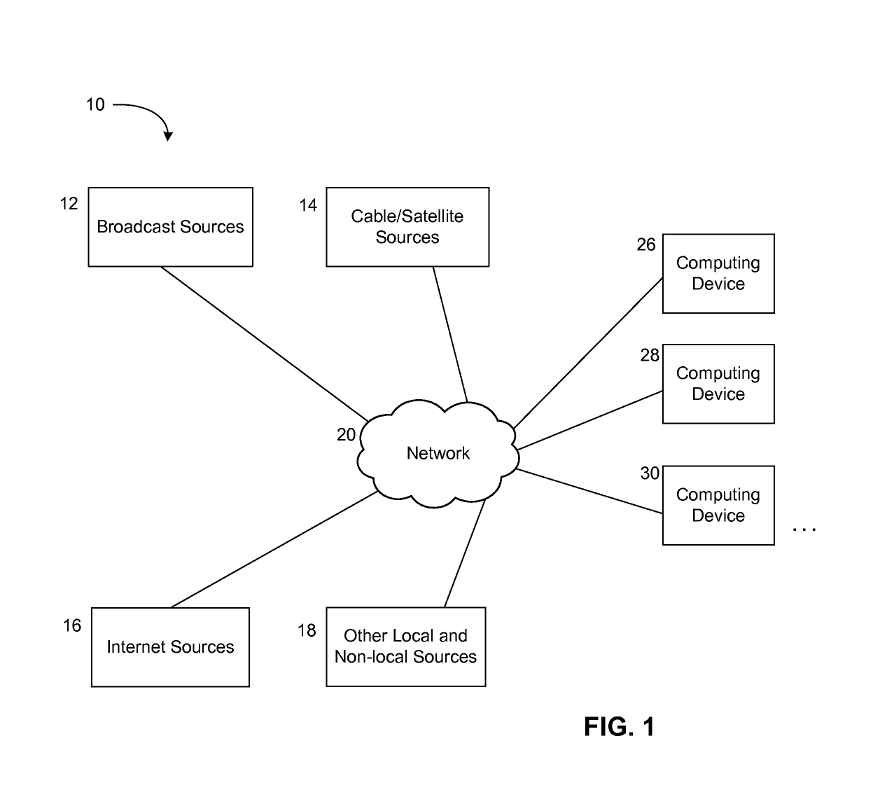

The systems and methods described herein can be implemented to aggregate media content from various sources. For example, as shown in FIG. 1, a system for aggregating media 10 is illustrated. In one embodiment, one or more broadcast sources 12, one or more cable/satellite sources 14, one or more Internet sources 16, and one or more other local and/or non-local sources 18 (also referred to herein as “rebroadcast” sources) are configured to be in communication with a network 20. As described in more detail below, network 20 can comprise a server that is configured to receive and distribute information via the Internet or other such network. In some embodiments, the network server can be configured to control one or more of the sources of information, including the rebroadcasting devices described herein.

Broadcast sources 12 can include network and local television terrestrial broadcasts. Cable and/or satellite sources 14 can include broadcasts from a user's home subscription service. Internet sources 16 can include television, video, and/or other media broadcasts delivered via the Internet. Rebroadcast sources 18 can include foreign local and true local media content received from a variety of locations via the rebroadcasting devices described herein. As described in more detail below, sourced media content can be delivered via network 20 to a plurality of computing devices (e.g., laptops, home computers, tablets, Internet-ready televisions, etc.) of subscribers to the system. For convenience, only three computing devices (computing devices 26, 28, 30) are shown in FIG. 1; however, many more computing devices can access the network 20 to receive media content.

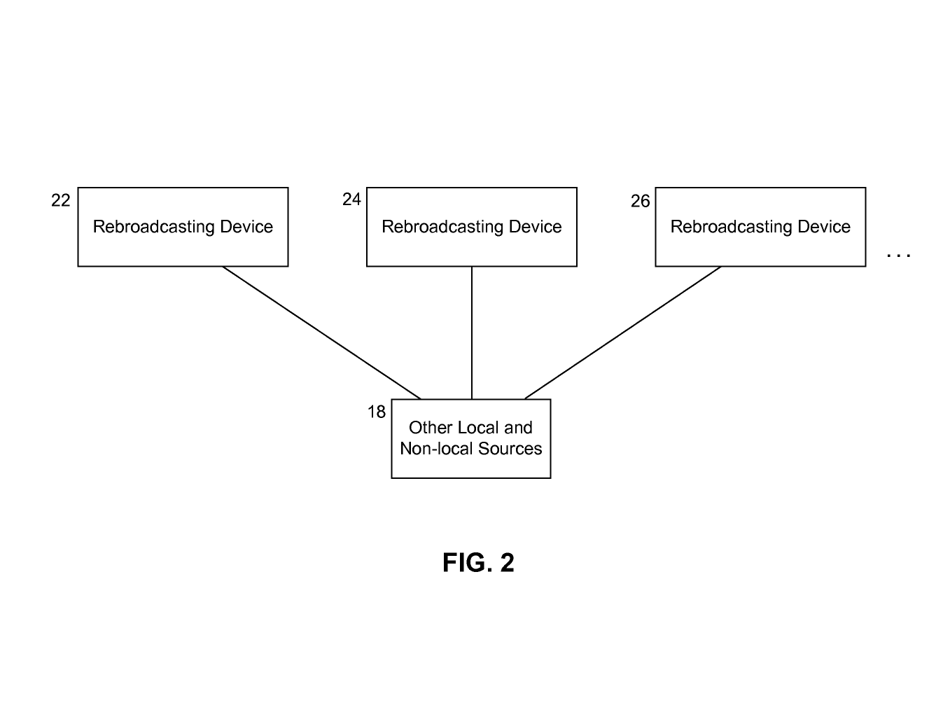

As shown in FIG. 2, in one embodiment, local media content can be collected and/or rebroadcast to increase the amount of content available to a subscriber of the system. For example, a plurality of rebroadcasting devices 22, 24, 26, etc., can be located near a broadcast or distribution source of local television content so that the local television content can be collected and/or rebroadcast by the rebroadcasting device 22. In some embodiments, the rebroadcasting device 22 can comprise a physical system, such as hardware coupled and/or otherwise connected to an Internet-accessible computer. The hardware can comprise, for example, one or more content-capturing means, such as a digital television tuner that is configured to collect one or more signals from a source. The captured content can be collected, stored, and rebroadcast to users via the network 20. In other embodiments, the content is not stored locally by the rebroadcasting device; instead, the rebroadcasting device is configured to simply redirect the signal to the rebroadcast sources 18 for storage and/or further rebroadcasting.

In some embodiments, the plurality of rebroadcasting devices can be configured to send the captured content information to a central location (e.g., to the network server) from which computing devices of subscribers can retrieve the signal. In other embodiments, one or more rebroadcasting devices can function as the direct source of the locally broadcast media content. In such a configuration, the plurality of rebroadcasting devices themselves can function as a distributed network in which the rebroadcasting device can individually or collectively transfer media content to a subscriber.

In some embodiments, the rebroadcasting device can comprise a tuner without any display functionality. In other embodiments, the rebroadcasting device can comprise a device that is capable of receiving, rebroadcasting, as well as locally displaying the stored media content. Although the rebroadcasting devices are described above as receiving and rebroadcasting local television content, it should be understood that other local media content can be captured, such as AM and FM radio content.

A plurality of rebroadcasting devices can be provided in geographically diverse locations. In addition, to the extent that there is more than one rebroadcasting device in any one location, those rebroadcasting devices can be used to either capture the same media content or different media content. If the same media content is being captured by multiple rebroadcasting devices, the system can analyze the quality of the media content capture and select the higher quality feed for further distribution via the network. Thus, for example, if there are more than one source of local television content being sent to the network via rebroadcasting devices, the system can select the high quality feed and use the alternative feeds as back-up feeds or, alternatively, change the channel on one or more of the lower-quality feeds to capture different content. Similarly, even if multiple high-quality feeds are available, it may be desirable to change the channel on at least some of the rebroadcasting devices to avoid unnecessary duplication of content.

In this manner, terrestrial broadcast television and other media content from remote locations, such as Paris, London, or anywhere in the world where digital content is broadcast, can be collected by the system and made available to other subscribers—either directly or indirectly. As a result, users in different locations can use their tuner to submit their own local content to the system so it can be resent to other users in different locations. That way a subscriber can, for example, watch “Paris” television while living in Los Angeles.

Locally captured media content can also be rebroadcast for the benefit of other “local” subscribers. Thus, for example, a subscriber can receive their own local broadcast television either via the terrestrial broadcast in the subscriber's area or from a source that obtained the media content from a rebroadcasting device in the same area of a user. In this manner, it can be assured that the subscriber is receiving the best quality signal available.

While all users can benefit from the rebroadcasting devices, only a portion of the users need to have rebroadcasting devices in order to experience these advantages. To encourage use of the rebroadcasting device by users, various incentives can be provided. In one embodiment, use of a rebroadcasting device can “unlock” foreign broadcast television to that user without charge (or for a reduced charge). Thus, users can easily watch local programming and locally broadcasted national programming, all sourced from “air wave” broadcasts anywhere in the world, as long as a user has installed a rebroadcasting device in his/her location.

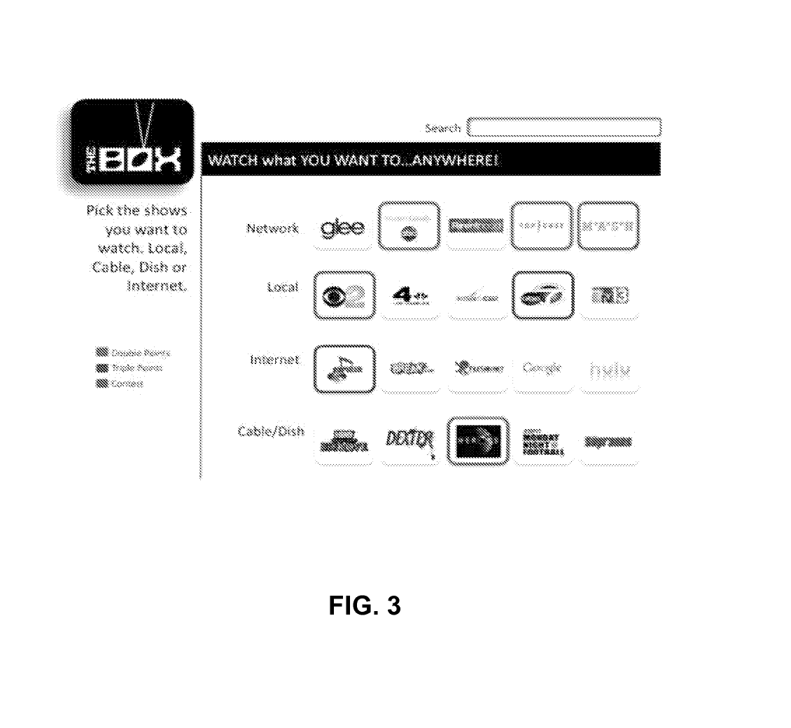

In other embodiments, a system for controlling the multiple content sources is provided. As shown in FIG. 3, that system can include a graphical user interface that permits subscribers to select from various available media content. In the exemplary embodiment, the system is called “The Box.” As shown in FIG. 3, a subscriber can select from a plurality of available television programs to watch.

In some embodiments, viewers can be presented with a plurality of television programs to select from and the list can change from hour to hour, depending on the availability of content. In some embodiments, each “set” of shows displayed by the graphical user interface can be at least partially based on user demographics and user preferences.

In some embodiments, the computing devices that can access the media content includes any of the computing systems described herein, including tablets, home computers, and smart phones. In one embodiment, the graphical user interface comprises a software application that can be run on the computing device, such as an app for an iPad™. Video and television content (and other media content) can be selected for delivery to the user's computing devices (e.g., an iPad™) upon providing an indication via an input mechanism, such as by selecting an icon on the touch screen display of the iPad™.

The screenshot shown in FIG. 3 is of a graphical user interface configured for use with a tablet or other mobile device. As shown in FIG. 3, the screen illustrates a “grid” of available content for the user to select from. As described above, the plurality of media content can be selected from broadcast sources 12, cable/satellite sources 14, Internet sources 16, and rebroadcast sources 18. For locally-sourced media content from broadcast sources 12, the media content can be received directly by the computing device and/or via the network from a plurality of rebroadcasting devices. Thus, for example, even locally available information can be received via the network. By utilizing information obtained via rebroadcasting devices, users who are “local” to a broadcast but not in a good position to obtain high quality reception (e.g., because of environment, weather, or other technological difficulties), can receive a high quality stream of local media content.

For subscription-based content (e.g., cable/satellite sources), a user may have to establish access to such content. For example, if the user pays for cable/satellite television content at home or work, the user can be prompted to enter in the name of the content provider, such as “DeltaCableAtlanta” along with sufficient information to establish access to that content. Once access is established, that content will be “unlocked” for the user to access via the computing device (e.g., iPad™) and/or will be received via the Internet through the content provider's own designated app.

As described above, the system can be configured to permit “Internet” sourced content. In some embodiments, premium “Internet” content may also be available to the user. In such cases, as with cable/satellite content, the user may have to enter sufficient information (e.g., user names and passwords) to establish proper access to that premium content. Internet based subscription content can include, for example, Hulu™ Premium, EarDish™ premium, paid for video on demand, etc.

To encourage the use of rebroadcasting devices and the rebroadcasting sourcing efforts by subscribers, subscribers who install and use rebroadcasting devices can be provided with various incentives. For example, in one embodiment, purchases and users of the rebroadcasting devices can be given additional rewards for sourcing content broadcast system/application. Such rewards can include free access to content. For example, in one embodiment, incentives can include free Internet content can be provided as it is available (e.g., via premium subscriptions to Hulu™, YouTube™, Eardish™ native content, etc.) and/or free “local” broadcast TV from other users in other parts of the nation and/or world-sourced from those user's rebroadcasting devices.

Exemplary Viewing Bonuses

Encouragement for users to watch or listen to certain content can be provided by offering contents and sweepstakes based on the viewing efforts of subscribers. For example, subscribers can be informed via graphic display in the application itself (and via email) that certain programs, if selected by the user, will provide “additional” rewards if they view the programs. Rewards can include entries into sweepstakes, discounts for products and in some cases, a cash payment (e.g., to an online wallet).

Any user will receive “points” in various degrees for using the app itself, which is a “basic” point reward system. In some embodiments, point values can vary depending on the demographics of the user. For example, in some embodiments, an 18 year-old female in NYC may receive more points than a 65 year-old male in Los Angeles, with such points being “paid for” by advertisers or content owners who wish to promote their specific shows. This describes a cost per engagement system where advertisers can “buy” users in both number and with specific demographics in order to increase the number of viewers as well as users based on desired demographics, online buying history, records of recent online product searches and content viewing, click through rates per user and other useful data points.

Users are provided a wealth of video/television content to select from. Their content selections are influenced via positive and intermittent reinforcement techniques such as points used for rewards, cash, and sweepstakes entries. Advertisers benefit from selling advertising that is targeted based on demographic information and user online behavior histories via a cost per engagement model.

In some embodiments, commercials can be inserted into “free” content available for use, or that can be licensed for use. This enables non-network material that is commercial free to have commercials engaged. Commercials of this nature can be interactive, whereby a user can take an action that can be electronically tracked, which can then be used for additional marketing purposes. This information can assist advertisers wanting to identify specific marketing groups. Advertisers could be charged additional fees for use of this service based on exposure of the user to the commercial, or an action by a user such as a purchase, click on an ad that directs the user to another site, or that generates an automatic email to the user and so forth.

Broadcasters may pay to influence viewers to watch their specific content (shows containing commercials). Furthermore, networks can pay to drive traffic to underperforming network or local shows.

Exemplary Rebroadcasting Devices

The rebroadcasting devices described herein can comprise manufactured TV tuners that are connected and/or otherwise wirelessly coupled to a user computer. The system can be configured with software that instructs the tuner which channel to tune to and receive. In some embodiments, the tuner can include a plurality of channels so that it can receive signals for two or more shows at a time. In certain implementations, the rebroadcasting device can encode the airwave digital information such as MPEG video or other suitable formats prior to sending to a central location (e.g., the network server) for rebroadcasting. In other embodiments, the rebroadcasting device can simply redirect the signal in its native format to the network server.

Some rebroadcasting devices can be configured to receive whatever channel(s) are selected. Other rebroadcasting devices can be configured to receive different shows broadcast in a user's physical location, or rather, the location of the user's rebroadcasting device, and that content can be sent to the network and redistributed over the network to users in other locations. Thus, for example, a user can watch television broadcasted on the airwaves in Los Angeles, or have the ability to watch it from another city, such as London, because one or more rebroadcasting devices in Los Angeles have sent the content to the network to be rebroadcast via the Internet to other users.

In some embodiments, other digital video recording devices can be linked into the system to provide content for rebroadcasting by the network. For example, functionality can be provided for users to upload content captured via other sources than those explicitly described herein.

Exemplary Content Rating Systems and Methods

In some embodiments, methods and systems for providing advanced ratings information can be implemented. Conventional ratings systems, such as the Nielsen™ system, are based on “household” viewing statistics. For example, Nielsen™ television ratings are gathered by either “viewer diaries” or “set meters.” A viewer diary requires a target audience to self-record its viewing or listening habits. By targeting various demographics, the assembled statistical models provide a rendering of the audiences of any given show, network, and programming hour. A more technologically sophisticated system uses Set Meters, which are small devices connected to televisions in selected homes. These devices gather the viewing habits of the home and transmit the information nightly to Nielsen™ through a “Home Unit” connected to a telephone line. The technology-based home unit system is meant to allow market researchers to study television viewing habits on a minute to minute basis, seeing the exact moment viewers change channels or turn off their TV. In addition to Set Meters, individual viewer reporting devices, such as people meters, have allowed the company to separate household viewing information into various demographic groups. Because viewing patterns across multiple sources of media content cannot be easily tracked, however, the amount of information that can be derived from such conventional methods is limited. For example, Nielsen™ ratings are generally restricted to content viewed via conventional television sources.

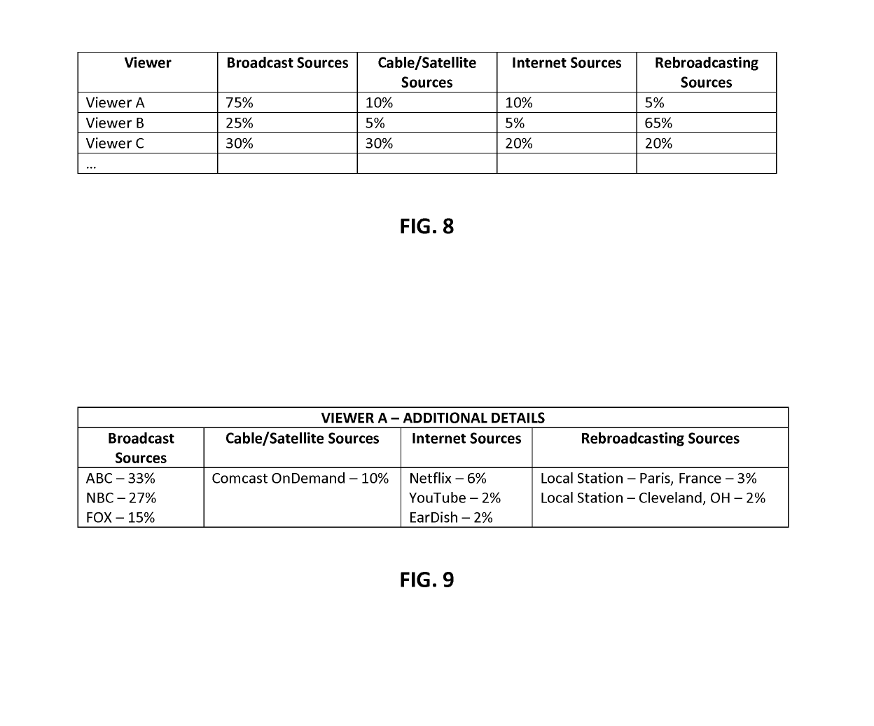

The systems and methods disclosed herein provide advanced statistics and feedback mechanisms which allow content generators and advertisers to more accurately target audiences. In one embodiment, viewing patterns can be analyzed for media content derived from a plurality of sources, including, for example, broadcast sources, Internet sources, rebroadcast sources, and subscriptions sources (such as cable and/or satellite). For example, FIG. 8 illustrates an example of summarized viewing patterns of a plurality of viewers (e.g., Viewer A, Viewer B, Viewer C, etc.). For each viewer, media content that is delivered to that viewer can be analyzed. Thus, as shown in FIG. 8, it can be understood that Viewer A receives 75% of his/her viewing entertainment from broadcast sources, 10% from cable/satellite sources, and 5% from rebroadcasting sources. FIG. 8 illustrates similar summarized viewing preferences for additional Viewers B and C.

Moreover, this information can be more particularly analyzed for each viewer. Thus, as shown in FIG. 9, the system can be configured to analyze and identify the content that is viewed from each source of content. Thus, as shown in FIG. 9, the 5% of rebroadcasting sources viewed by Viewer A can be further broken down to 3% from a local station in Paris, France and 2% from a local station in Cleveland, Ohio, both of which have been rebroadcast for local viewing by Viewer A in his geographical location.

In addition, instead of identifying the source of content (e.g., from a particular network or station), as shown in FIG. 9, the system can also be configured to analyze the information based on specific media content. In this manner, the system can review the information obtained and determine what specific content is being watched by what source. For example, it can be determined that the television shown South Park™ is being watched more often via Internet sources (e.g., Netflix) than via conventional broadcast sources, or vice versa. This type of information can be particularly helpful to media content generators when they are making decisions as to what medium they want to use to distribute their content.

Similarly, the ratings information gleaned by individual users can also be used to more directly market certain information to the viewer. For example, knowing that the viewer is a regular watcher of content being rebroadcast from a certain location can be helpful in suggesting other services and products that the user may have an interest in. Thus, for example, a user that regularly watches rebroadcasts of local stations in Cleveland, Ohio can receive directed advertising for other products and services that have a geographic connection to that area.

Currently, conventional systems have a particularly difficult time tracking viewer preferences across various media sources. However, the aggregator systems and methods described herein are particularly well-suited for identifying and analyzing this information because multiple sources of media content are able to be distributed by the system. The ability to track viewer preferences across these various media content sources can also provide unique insights into patterns that would not otherwise be understood. For example, it may be realized that viewers of a particular show distributed via broadcast sources are also very likely to enjoy a particular show distributed via Internet sources. Unlike conventional ratings systems, such connections can easily be made by tracking viewing content using the media content aggregator systems described herein.

Accordingly, as described above the system provides for statistics to be gathered through a network platform that provides actual user demographics across various media content sources. As described above in more detail, various methods and systems for selecting viewing content from multiple sources can be provided. When the user selects that content for viewing, the system can track what that user is viewing and when regardless of the source of the media content. In addition, in some embodiments, the registration of a user requires the entry of certain demographic information. Accordingly, the system is able to compile additional demographic information about viewing patterns by registered users of the system.

Thus, by controlling the medium through which content is distributed to users (e.g., via the network server), actual users (i.e., viewers of content) can be identified along with their viewing preferences (regardless of source) and demographics (such as gender, age range, and location) to provide highly accurate information about actual viewing patterns.

In addition, the system and methods described herein can also identify other specific viewing actions and patterns, such as actual shows being watched (and when it is watched), the amount of time a show is watched, if watching is interrupted during broadcast (and when it was interrupted), if a user stops watching in a middle of a show and turns to another show (and which show he turns to), amount of time watching television via terrestrial broadcast, amount of time watching Internet television, amount of time watching cable television, amount of time using computer or television to play games or use non-television style entertainment services. In some embodiments, subgroups of ethnic data as determined by viewing content analysis can be provided to further identify and correlate viewing patterns.

In addition, because the graphical user interface is linked to a variety of sourced content, including television and Internet, user reaction to advertising can be measured by an indication that user purchased related products via the Internet and/or requested further product information. In some embodiments, the network server can also function as a social network, thereby eliciting further information from registered viewers about the content that is viewed. In addition, various types of promotions can be provided, such as sweepstakes and contests, and for each instance the demographics and other information about the participants can be analyzed.

Additional statistical information can include an amount of email users receive and open, and the amount of time a user spends at locations on the Internet, such as broadcaster's websites, Twitter™ pages, Facebook™ and other broadcast/content owner social network sites. Accordingly, the ratings content that can be gathered using the methods and systems described herein is significantly more relevant than what has been previously achievable, thereby providing a broader picture of statistics in substantially real time.

Implementation of the Systems and Methods Disclosed Herein

Various systems for aggregating media content in the manners described above can be provided, such as the methods for selecting from one or more choices of television content from a graphical user interface. In some embodiments, these systems may be implemented or performed by software stored on one or more tangible computer-readable media (e.g., one or more optical media discs, volatile memory or storage components (such as DRAM or SRAM), or nonvolatile memory or storage components (such as hard drives)) and executed on one or more computing systems. The computing systems can include one or more central processing units (CPUs) and a memory, such as random access memory (RAM) for temporary storage of information and/or a read only memory (ROM) for permanent storage of information, and a mass storage device, such as a hard drive, diskette, or optical media storage device. Typically, the modules of the computing system are connected to the computer using a standards-based bus system, such as, for example, Peripheral Component Interconnect (PCI), Microchannel, SCSI, Industrial Standard Architecture (ISA) and Extended ISA (EISA) architectures. The computing system may also include one or more commonly available input/output (I/O) devices and interfaces, such as a keyboard, a mouse, and/or a touchpad. In one embodiment, the I/O devices and interfaces include one or more display devices, such as a monitor, that allows the visual presentation of data to a user. More particularly, a display device provides for the presentation of Graphical User Interfaces (GUIs), application software data, and multimedia presentations, for example. The computing system may also provide a communications interface to various external devices.

Such software can be executed on a single computer or on a networked computer (e.g., via the Internet, a wide-area network, a local-area network, a client-server network, or other such network). The systems and methods disclosed herein can also be performed using cloud computing, a form of Internet-based computing, whereby shared resources, software and information are provided to computers and other devices on-demand. The software embodiments disclosed herein can be described in the general context of computer-executable instructions, such as those included in program modules, which can be executed in a computing environment on a target real or virtual processor. The computing system may run on a variety of computing devices, such as, for example, a server, a Windows server, a Structure Query Language server, a Unix server, a personal computer, a mainframe computer, a laptop computer, a cell phone, a personal digital assistant, a kiosk, an audio player, and so forth. The computing system is generally controlled and coordinated by operating system software. Conventional operating systems control and schedule computer processes for execution, perform memory management, provide file system, networking, and I/O services, and provide a user interface, such as a graphical user interface, among other things.

Furthermore, any of the software embodiments (comprising, for example, computer-executable instructions for causing a computer to perform any of the disclosed methods) can be transmitted, received, or accessed through a suitable communication means. Similarly, any data structure, data file, intermediate result, or final result created or modified using any of the disclosed methods can be transmitted, received, or accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means now known or unknown. Moreover, any data structure, data file, intermediate result, or final result produced by any of the disclosed methods can be displayed to a user using a suitable display device (e.g., a computer monitor or display). Such displaying can be performed as part of a computer-implemented method of performing any of the disclosed methods.

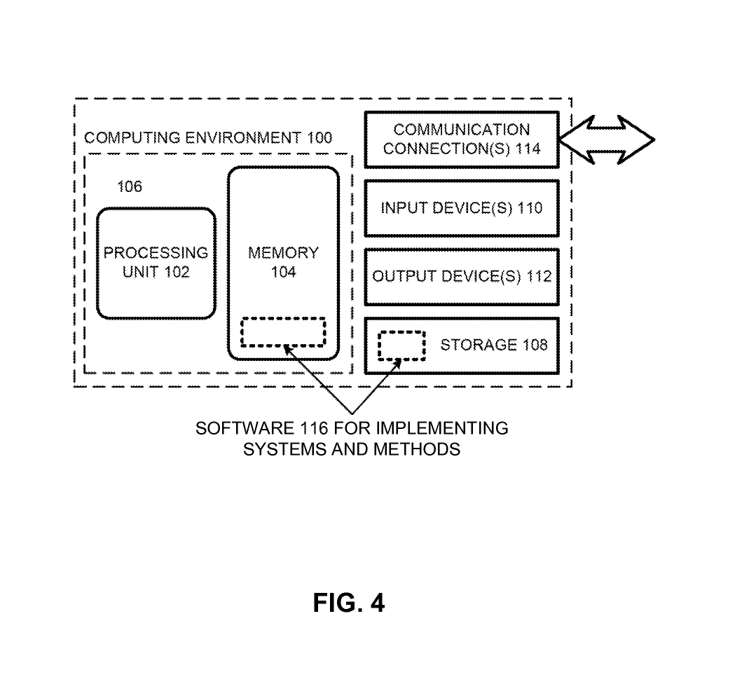

FIG. 4 illustrates a generalized example of a suitable computing environment 100 in which the described embodiments of systems and methods of aggregating media content can be implemented. The computing environment 100 is not intended to suggest any limitation as to scope of use or functionality, as the methods described herein can be implemented in diverse general-purpose or special-purpose computing environments.

With reference to FIG. 4, the computing environment 100 includes at least one processing unit 102 and memory 104. In FIG. 4, this most basic configuration 106 is included within a dashed line. The processing unit 102 executes computer-executable instructions and may be a real or a virtual processor. In a multi-processing system, multiple processing units execute computer-executable instructions to increase processing power. The memory 104 may be volatile memory (e.g., registers, cache, RAM), non-volatile memory (e.g., ROM, EEPROM, flash memory, etc.), or some combination of the two. The memory 104 stores software 116 implementing one or more of the systems described herein.

The computing environment may have additional features. For example, the computing environment 100 includes storage 108, one or more input devices 110, one or more output devices 112, and one or more communication connections 114. An interconnection mechanism (not shown) such as a bus, controller, or network interconnects the components of the computing environment 100. Typically, operating system software (not shown) provides an operating environment for other software executing in the computing environment 100, and coordinates activities of the components of the computing environment 100.

The storage 108 may be removable or non-removable, and includes magnetic disks, magnetic tapes or cassettes, CD-ROMs, DVDs, or any other medium which can be used to store information and which can be accessed within the computing environment 100. The storage 108 can store instructions for the software 116 implementing any of the described systems and methods.

The input device(s) 110 can be a touch input device such as a keyboard, mouse, pen, or trackball, a voice input device, a scanning device, or another device that provides input to the computing environment 100. For audio or video encoding, the input device(s) 110 can be a sound card, video card, TV tuner card, or similar device that accepts audio or video input in analog or digital form, or a CD-ROM or CD-RW that reads audio or video samples into the computing environment 100. The output device(s) 112 can be a display or another device that provides output from the computing environment 100 to view the selected media content.

The communication connection(s) 114 enable communication over a communication medium to another computing entity. The communication medium is not a storage medium but conveys information such as computer-executable instructions, resource and construction project information, or other data in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

The various methods disclosed herein can be described in the general context of computer-readable media. Computer-readable media are any available media that can be accessed within or by a computing environment. By way of example, and not limitation, with the computing environment 100, computer-readable media include tangible computer-readable storage media such as memory 104 and storage 108.

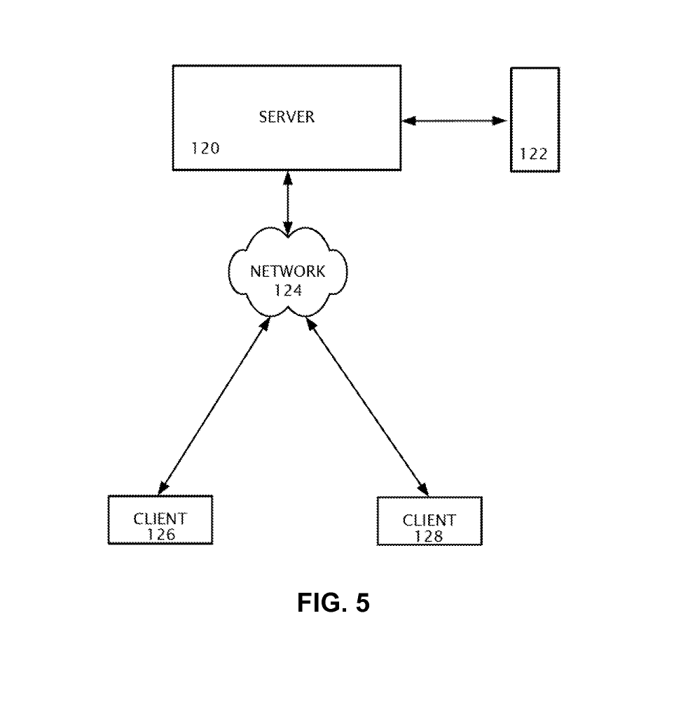

Any of the aspects of the technology described herein can also be performed using a distributed computer network. FIG. 5 shows a simplified embodiment of one such exemplary network. A server computer 120 can have an associated storage device 122 (internal or external to the server computer). For example, the server computer 120 can be configured to perform the calculations and analysis of information according to any of the disclosed embodiments. The server computer 120 can be coupled to a network, shown generally at 124, which can comprise, for example, a wide-area network, a local-area network, a client-server network, the Internet, or other such network. One or more client computers, such as those shown at 126, 128, may be coupled to the network 124 using a network protocol. The work may also be performed on a single, dedicated workstation, which has its own memory and one or more CPUs.

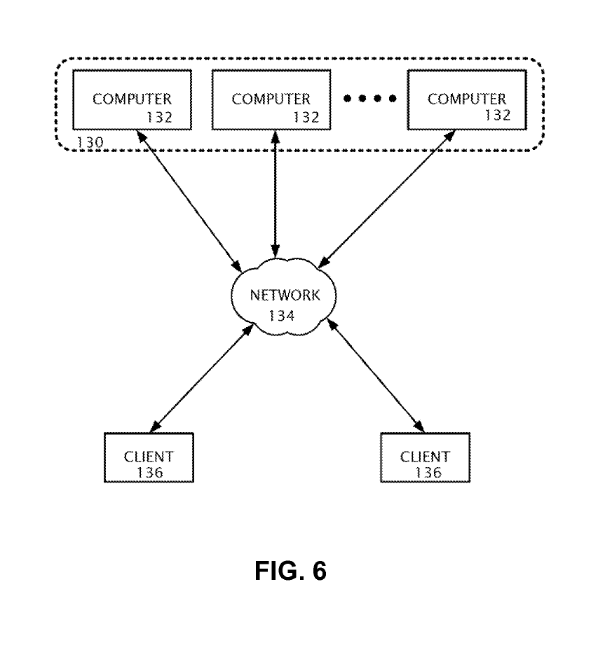

FIG. 6 shows another exemplary network, such as a network which can send and receive information and media content to the computing devices 26, 28, 30. One or more computers 132 communicate via a network 1304 and form a computing environment 130 (e.g., a distributed computing environment). Each of the computers 132 in the computing environment 130 can be used to perform at least a portion of the calculation techniques according to any of the disclosed embodiments. The network 134 in the illustrated embodiment is also coupled to one or more client computers 136.

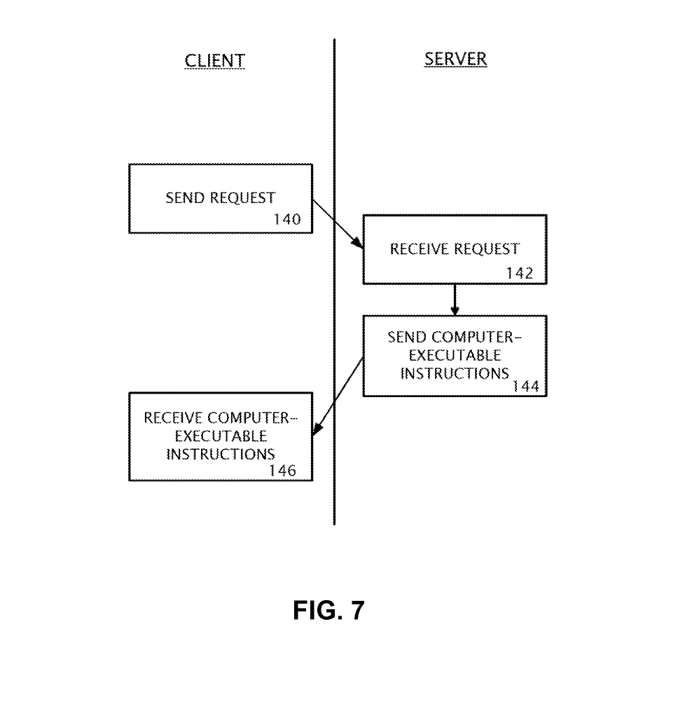

FIG. 7 shows one exemplary manner in which computer-executable instructions for performing any of the disclosed embodiments can be transmitted, accessed, or received using a remote server computer (such as the server computer 120 shown in FIG. 5) or a remote computing environment (such as the computing environment 130 shown in FIG. 6). At process block 140, for example, the client computer sends a request to download computer-executable instructions for performing any of the disclosed methods or techniques (e.g., after registering or logging in to the system). In process block 142, the request is received by the remote server or by respective components of the remote computing environment. In process block 144, the remote server or computing environment transmits computer-executable instructions for performing any of the disclosed methods or techniques. At 146, the computer-executable instructions are received (e.g., stored, buffered, and/or executed) by the client computer.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope and spirit of these claims.

We claim:

1. A method of aggregating media content for rebroadcasting, the method including:
providing a plurality of rebroadcasting devices at a plurality of different geographic locations, at least some of the plurality of rebroadcasting devices comprising digital television tuners;
controlling the plurality of rebroadcasting devices to receive local television broadcasts via their respective digital television tuners and upload the received local television broadcasts to a network server;
receiving, by the network server, the uploaded local television broadcasts from the respective rebroadcasting devices; and
delivering one or more of the uploaded local television broadcasts to one or more computer devices via the Internet.

2. The method of claim 1, wherein the act of providing the plurality of rebroadcasting devices comprises delivering a plurality of rebroadcasting devices to a plurality of users, the plurality of users being located in different geographic locations, and wherein the plurality of users are provided with one or more free services in exchange for their use of the rebroadcasting devices.

3. The method of claim 1, wherein the act of receiving the uploaded local television broadcasts comprises receiving the uploaded local television broadcasts in a different format from which they were received by the rebroadcasting devices.

4. The method of claim 1, wherein the act of receiving the uploaded local television broadcasts comprises receiving the uploaded local television broadcasts in the same format from which they were received by the rebroadcasting devices.

5. The method of claim 1, wherein the act of delivering one or more of the uploaded local television broadcasts to one or more computer devices via the Internet comprises rebroadcasting local television broadcasts to a user, wherein the local television broadcast is not available via local broadcasting airwaves.

6. The method of claim 1, wherein the act of delivering one or more of the uploaded local television broadcasts to one or more computer devices via the Internet comprises rebroadcasting local television broadcasts to a user, wherein the local television broadcast is available via local broadcasting airwaves.

7. The method of claim 2, further comprising:
registering users of the plurality of computing devices with the network server;
receiving demographic information about the users during registration; and
storing information about the uploaded local television broadcasts that are delivered to the one or more computer devices via the Internet

8. The method of claim 1, further comprising receiving, by the server computer, media content from the Internet, media content from cable and satellite sources, the method further comprising:
receiving, from one of the computing devices, an indication of whether to deliver one or more of the uploaded local television broadcasts to the one or more computer devices, media content from the Internet, or media content from cable and satellite sources to the one or more computing device.

9. The method of claim 8, further comprising:
responsive to the indication, delivering the indicated uploaded local television broadcast, media content from the Internet, or media content from cable and satellite sources to the one or more computing device.

10. A system for rebroadcasting local media content, the system comprising:
a plurality of rebroadcasting devices, each rebroadcasting device comprising a television tuner for capturing digital television content; and
a network server configured to control the operation of the rebroadcasting devices, the network server being configured to select a channel for capturing digital television content for the rebroadcasting devices.

11. The system of claim 10, wherein the network server is configured to receive uploaded digital television content and rebroadcast that uploaded digital television content via the Internet.

12. The system of claim 10, wherein the rebroadcasting devices comprises a plurality of television tuners so that the rebroadcasting devices are capable of receiving a plurality of channels at a time.

13. The system of claim 10, wherein the rebroadcasting devices comprises a storage device, the storage device being configured to store files of one or more captured digital television content, the storage device being configured to store the file in a different file format than that which the rebroadcasting device originally received.

14. The system of claim 10, wherein the network server is configured to analyze the quality of signals received from the rebroadcasting devices and distinguish between higher quality and lower quality signals of different rebroadcasting devices for the same captured digital television content.

15. The system of claim 11, wherein the network server is configured to receive demographic information about a user prior to rebroadcasting uploaded digital television content via the Internet to the user.

16. A graphical user interface for selecting media content for viewing, the graphical user interface comprising:
a grid of selectable media content;
a first group of selectable media content displayed in the grid, the first group comprising local broadcast-sourced media content that has been uploaded to a network server for rebroadcasting;
a second group of selectable media content displayed in the grid, the second group comprising internet-sourced media content; and
a third group of selectable media content displayed in the grid, the third group comprising subscription-based media content.

17. The graphical user interface of claim 15, wherein the third group of selectable media content comprises one or more of cable- or satellite-sourced media content.

18. The graphical user interface of claim 15, wherein the first group of selectable media content comprises media content that has been originally broadcast in geographically diverse locations.

19. The graphical user interface of claim 15, wherein the grid of selectable media content is selected, at least in part, on predetermined user demographics and preferences.

20. The graphical user interface of claim 15, further comprising a location on the interface for entry of user information relating to the subscription-based media content, the user information comprising one or more user names and passwords.
